(19) United States
(12) Patent Application Publication
(10) Pub. No.: US 2007/0260350 A1
(43) Pub. Date: Nov. 8, 2007

(54) Method for Improving Efficiency of a Manufacturing Process Such as a Semiconductor Fab Process

(76) Inventor: Maxim Zagrebnov, Montpellier (FR)

Correspondence Address: OKAMOTO & BENEDICTO, LLP, P.O. BOX 641330, SAN JOSE, CA, 95164, US

(21) Appl. No.: 11/660,344

(22) PCT Filed: Aug. 22, 2005
(86) PCT No.: PCT/IB05/03265

§ 371 Date: Feb. 15, 2007

Related U.S. Application Data
(60) Provisional application No. 60/603,321, filed on Aug. 20, 2004.

(51) Int. Cl. G05B 19/418

(52) U.S. Cl. 700/121; 700/109

(57) ABSTRACT

The present invention provides a method for improving the efficiency of a product manufacturing process such as a semiconductor fab process, wherein a given step of the process has a quality result which can be actually measured on each product or group of products, and wherein the process comprises a subsequent, adjustable step, the method comprising:—providing a correlation model of the behavior of said given step as a function of available parameters;—for each product or group of products at the output of said manufacturing step, computing a predicted quality result based on said correlation model as a function of the actual values of the parameters during the manufacturing step, and—providing the quality result to a control system for adjusting said subsequent step.

The present invention relates in general to quality monitoring in a manufacturing plant environment, and more specifically to a method of quality monitoring intended to conduct manufacturing processes in a more effective way, in particular in the environment of a semiconductor fab.

### BACKGROUND OF THE INVENTION

In a modern semiconductor fab handling 200 mm or 300 mm semiconductor wafers, cost reduction is one of the most important factors to achieve competitiveness. For this purpose, metrology tools, Fault Detection and Classification (FDC) tools, Run-to-Run (R2R) tools and Yield Analysis tools have been introduced to make processing more efficient.

More particularly, while FDC controls the process, helps to reduce scrap and number of test wafers, metrology controls the process performance by analyzing process “output” critical parameters such as deposited thickness, etch depth & rate, CD, etc.

In the permanent search for maximized efficiency, it is clear that by substantially reducing the metrology sampling (i.e. the number of wafers undergoing metrology measurements), the fabs would be able to reduce cycle time, cut costs and thus improve their competitive advantages.

In this regard, so-called stand-alone (in-line) metrology is often seen as a bottleneck—too slow, low wafers throughput, wafers transfer required, etc. Another known approach is so-called Integrated Metrology (IM), which aims to overcome such weaknesses by integrating measurement tools—linked by appropriate software and hardware—to manufacturing tools. However, integration of Metrology tools into production equipment remains costly and difficult task as well as the time required for calibration of the integrated metrology itself still limits its application.

### SUMMARY OF THE INVENTION

The underlying idea of the present invention is that, by applying mathematical analysis to standard, readily available FDC “input” parameters, it is possible for certain steps of a fab process to predict a quality classification of the products as output for these process steps.

For instance, in a CVD deposition step, FDC input parameters such as RF power, pressure, temperature, etc. can be subjected to an appropriate Multivariate Analysis technique together with “plasma physics” modeling algorithm, so as to lead to a wafer classification such as “good”=nominal thickness/uniformity, or “bad”=call for metrology.

In other words, the present invention seeks to provide “Virtual Metrology” based on the process information already available through FDC and appropriate mathematical algorithms, describing the process “physical side” which will help to adjust metrology sampling rate and select the wafers which have to go through in-line metrology instead of performing random sampling (i.e. random metrology sampling selection).

To that effect, the present invention provides according to the first aspect a method for improving efficiency of a product manufacturing process such as a semiconductor fab process, wherein a given step of the process has a quality results which can be actually measured on each product or group of products, comprising:

providing a correlation model of the performance of a given step as a function of available process parameters;

for each product or group of products at the output of said manufacturing step, computing a predicted quality result based on said correlation model as a function of the actual values of the parameters during the manufacturing step;

only if the predicted quality result is lower than a predetermined threshold, selecting the product or group of products for in-line measurement (metrology).
Some preferred but non limiting aspects of this method are as follows:
said predicted quality result includes a value and a degree of confidence of said value.
the method further includes a correlation model calibration based on actual result of quality measurement on a plurality of product samples.
said process step is a plasma deposition step.
said manufacturing process further comprises a subsequent, adjustable step, and the method further comprises providing the quality result to a control system for adjusting said subsequent step.
said subsequent step is a chemical mechanical polishing (CMP) step.
the adjustment of said CMP comprises adjustment of the duration of an over-polish phase of said subsequent step.
said subsequent step is an etching step.

According to a second aspect, the present invention provides a method for improving the efficiency of a given product manufacturing process such as CMP process based on the information retrieved from the previous processing step (plasma deposition) through FDC system and corresponding correlation algorithm. The given step of the process has a quality result which can be actually measured on each product or group of products.

Preferably, said given step is a plasma deposition step and said subsequent step is a chemical mechanical polishing step.

### BRIEF DESCRIPTION OF THE DRAWINGS

The present invention will be better understood from the following detailed description of a preferred but non limiting embodiment thereof, made with reference to the appended drawings in which:

FIG. 1 schematically illustrates a High Density Plasma Chemical Vapor Deposition (HDP-CVD) process and the correlation between tool control and plasma physics parameters, to which the present invention can be applied,

FIG. 2 is a flow chart illustrating the main steps of a quality monitoring method of the present invention,

FIG. 3 illustrates the architecture in which the present invention is integrated,

FIG. 4 is a flow diagram illustrating a subsequent Chemical Mechanical Polishing (CMP) step of the process,

FIG. 5 is a data flow chart illustrating the various data exchanges when implementing the present invention,

FIGS. 6 and 7 are flow charts illustrating the behavior of the global manufacturing system in two cases of quality prediction,

FIG. 8 illustrates in greater detail the behavior of the system when abnormal quality (“out-of-control”) results are generated by the method of the present invention,

FIG. 9 illustrate the corresponding variations of the most influential parameters of the process, and

FIG. 10 is a table showing FDC results: under control and the most impacted parameters (out-of-control), the predicted CVD deposition rate, resulting “raw” predicted thickness and the actually measured thickness.

### DETAILED DESCRIPTION OF A PREFERRED EMBODIMENT

The following description will be made with reference to a specific process step example of High Density Plasma Chemical Vapor Deposition (HDP-CVD) of Fluorine-doped Silicate Glass oxide (FSG), followed by a Chemical Mechanical Polishing (CMP) step.

We shall also consider in this example that the output quality of this step is the thickness and/or uniformity of the deposited layer, as can be physically measured by Laser Interferometry or the like, in a manner known per se.

However, as will be apparent from the following, the skilled person will be able to extend this example to other deposition techniques where the influence of the various parameters on the layer quality is modeled accordingly, as well as to any other manufacturing process step which meets similar conditions.

a) Plasma Fundamentals

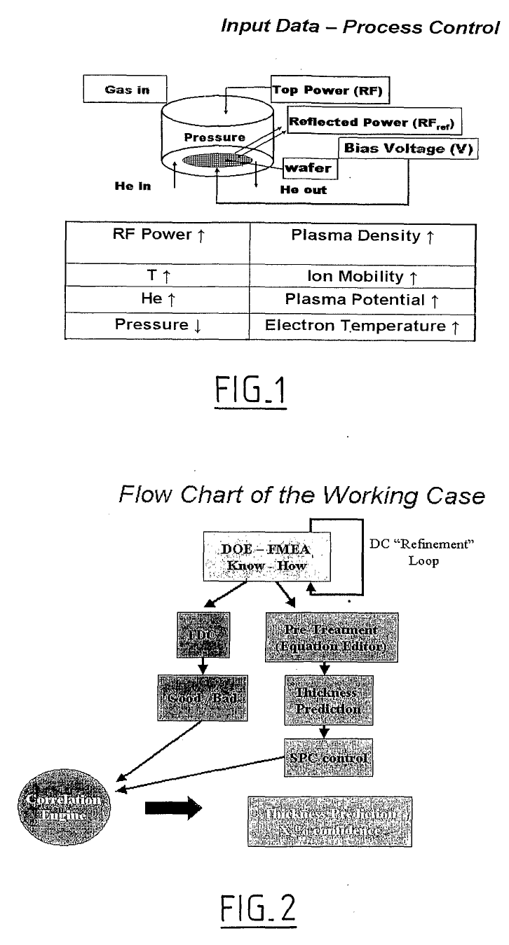

In a known manner, process of plasma assisted material deposition on wafer surface can be mathematically described through physical parameters such as Pressure, wafer temperature, RF Bias, gas flow rates, etc. FIG. 1 diagrammatically shows a plasma reactor, the related parameters and their influence.

Such known process is the combination of Deposition (D) and Sputtering (S), both taking the place at the same time. The D/S Ratio defines uniformity and quality of a resulting film. The ability to fill smaller gap widths depends on the directionality of deposition.

The factors that typically affect deposition are the following:
Reactor design/configuration (fixed electron-cyclotron resonance, which can be estimated)
Plasma density, uniformity and potential (which can be estimated)
Pressure (which can be measured directly)
Electron temperature (which can be estimated)
Wafer Temperature (which can be measured directly).

b) High Density Plasma Process Requirements

In the case of high density plasma oxide film deposition, in order to obtain the desired results of high deposition rate and good gap filling/planarity (and thus a high sputtering rate), a reactor that provides very high plasma densities (exceeding 10¹¹ electrons/cm³) is used. High sputter yield also requires acceleration of ions in the sheath to several hundred volts, so that high plasma potential (relative to the wafer) is also needed.

In addition, the deposition must occur at a well-controlled temperature (e.g. less than 400° C. for inter-metal dielectric applications), and with a well-controlled stoechiometry throughout the deposition.

These requirements lead to a reactor design which is radically different from the standard so-called “showerhead” plasma, and in particular:
Much lower pressures (a few mTorr) are needed to minimize scattering in the sheath and obtain high-energy, directional ions for sputtering; low pressure also helps to achieve good uniformity at high gas flows;
At low pressure, showerhead reactors cannot achieve high plasma density (because energetic sheath electrons pass right through the plasma); instead, an electron-cyclotron resonance or inductive excitation has to be used, and this places severe restrictions on reactor materials and design;
The requirement for high ion flux at high ion energy means that thousands of watts of power are dissipated on the wafer, which is in a vacuum environment where heat transport due to conduction and convection is negligible. With radiative equilibrium alone, the wafer will rapidly heat up to above 600° C. Some means of cooling the wafer is therefore provided; generally, the approach usually adopted is to dispense several Torrs of helium on the back of the wafer. This gas would cause the wafer to float away from the chuck, so a clamping mechanism (mechanical or electrostatic) is also provided.
Process control is of great importance: if the RF potential is turned on before the silane gas reaches the chamber, the edges of the metallization will be rapidly sputtered, causing dimensional loss and leakage from metal sputtered onto the oxide surface between the lines. To the contrary, if the silane is turned on before the RF potential is applied, the initial layers will not be sputtered and will have poor gap filling properties, with a risk to make it impossible to fill a high-aspect-ratio gap.

c) Plasma Properties and Correlation with “Available from Tool” Data

It is known that the voltage necessary to initiate a discharge is roughly a function of the mathematical product of the pressure and the spacing between electrodes. The minimum voltage occurs at a pressure×distance value of about 1 Torr.cm. At higher pressure×distance values, the discharge voltage increases, making it difficult to start the plasma if the electrode spacing is large.

At very low pressure×distance values, there are too few collisions and electrons traverse the chamber and strike the walls without ionizing. Again the voltage for initiating the discharge increases. For typical chamber geometries, it is very difficult to initiate a capacitive discharge at pressures less than 10 to 20 mTorr, although it is often possible to “strike” the discharge at higher pressure and then operate at only a few mTorr. This high breakdown voltage is exploited in making dark space shields, grounded plates placed within a few millimeters of a powered electrode to localize the plasma above the electrode.

The electron and ion diffusivity increase just like neutral diffusivities in a manner which is roughly proportional to 1/P. Thus at pressures of tens of mTorr, electrons diffuse readily and the plasma tends to spread through the reactor; at pressures of a few Torr and above, plasmas are generally confined to the regions where the electric fields heat the electrons (cf. “Basic Data of Plasma Physics”, S. Brown, American Inst. of Physics Press, 2001).

For reasonably high deposition rates, a very high plasma density is afforded to achieve significant ion bombardment effects. High Density Plasma Deposition occurs when the ion flux to the surface is larger than the net deposition flux. The ion flux is estimated from the Bohm velocity and the plasma density. The deposition flux can be calculated from the deposition rate and the molecular density. As an example, for deposition of silicon dioxide at 100 nm/minute, the molecular flux to the surface has to be 3.8E15 molecules/cm².second; this is equivalent to an electric current (of singly charged ions) of about 0.6 mA/cm². The plasma density required at the sheath edge to produce such a flux is at least 10¹¹ ions/cm³ (cf. “Principles of Chemical Vapor Deposition: What's Going on Inside the Reactor?” by Michael K. Zuraw and Daniel Mark Dobkin, Kluwer Academic Publisher, 2003).

It is also known from the above article that the maximum possible deposition flux for a given partial pressure of precursor material is given by the Knudsen Equation:

$$J = 3.51 \times {10}^{22} \frac{P}{\sqrt{MT}}$$

where

P is the pressure in Torr,

M is the molecular weight of the precursor material in grams/mole,

J is the flux in molecules/cm².second, and

T is the plasma temperature in ° K.

From this flux value, the deposited film thickness can be estimated from the following equation:
Virtual Thickness=“Raw” Deposition Rate*Processing Time*“Corrective Coefficient”.

Where:
“Raw” Deposition Rate is inversely proportional to the Knudsen Equation Deposition Flux J and thus roughly proportional to IT/P,
“Processing Time” is the duration of the deposition step (fixed and defined by user), and
“Corrective Coefficient” is a scaling coefficient (cf. infra) calculated by comparing the “Virtual Thickness” and the thickness as actually measured by metrology in an initialization phase of the method.

For example, and supposing a Corrective Coefficient of 0.9 as determined from experience, a targeted film thickness of 450 nm can be obtained with a Processing Time is 100 seconds for a “Raw” Deposition Rate estimated to be around 5 nm/s.

The example given at the end of the present description (table in FIG. 10) is based on these figures and gives estimation for deposition rate and resulting layer thickness as well as corresponding in-line metrology results.

It should be noted here that other parameters may significantly contribute to the “Pressure” and “Temperature” values. More particularly:

T may vary with Bias RF Power, Source RF Power, He in/out flow, SiH₄ gas flow, electrostatic chuck current and voltage, etc.;

P may vary with He in/out flow, throttle valve position, SiH₄ gas flow, Electrostatic Chuck current and voltage, etc.

Still more specifically:

a) The directionality of deposition controls the amount of sidewall growth, which needs to be minimized. In HDP-CVD plasma, non-directional deposition is primarily a result of neutral species. As the plasma density increases, the ratio of neutrals to ions decreases, resulting in bottom-up gap fill. Plasma density can be increased by the addition of source RF power. Increasing the source RF power results in problems with thermal management of the dome of the reactor. Dome temperature is monitored and indeed impacts the deposition. Bias RF power is also involved in increase in the wafer temperature.

b) A higher wafer temperature during deposition permits the reactive species to remain in a mobile “physisorbed” state for a longer time before becoming “chemisorbed” and forming covalent bonds. The greater mobility of the adsorbed species improves the conformity of the deposited oxide film. Higher wafer temperatures also increase the mobility of re-sputtered species and reduce the amount of re-deposited material. Parameters that are impacting temperature: He flow, which in its turn is function of electrostatic chuck voltage. Contaminations of electrostatic chuck leads to increased electrostatic chuck current, thus higher He flow and, as the consequence, lower temperature and higher internal pressure.

c) Finally, it has been proven by experience that lower pressure improves gap fill. Longer mean free paths at lower pressures—higher plasma densities and higher electron temperatures. It has been suggested that higher electron temperatures lead to improvements in gap fill performance; electron shading results in the deflection of the ion trajectories by a local electric field at the bottom of a high-aspect-ratio trench.

Turning now to the HDP-CVD deposition step in operation, it is known from practical experience that typical potential problems that can occur during deposition are as follows:
too high He flow, which leads to lower wafer temperature and increased Chamber Pressure;
electrostatic chuck degradation which lead to excessive leakage current and He flow;
too high dome temperature due to inefficient plasma clean, which leads to extra walls deposition and peal-off, provoking high chamber defectivity;
gas flows (depends on the line pressure or pressure in the canister);
throttle valve degradation (resulting in loss of angle control);
too high reflected Power due to polymers grow and non-efficient chamber clean (WAC).

The present invention provides a method for predicting the probability of the deposited thickness to be “good” or “bad”, based on the Virtual Thickness calculation as indicated above and on the influence of actually measured process parameters on the parameters used for this calculation.

We shall consider hare that the fab is equipped with a process control system such as the Maestria product currently commercialized by the assignee of the present application.

This system includes Fault Detection and Classification (FDC) with Statistical Process Control (SPC) and Hotelling T2 based Multivariate Analysis (MVA) for Detection as well as Principle Components Analysis for Classification. More details about the Maestria software are available at the www.siautomation.com website.

All plasma-related parameters data available as the output of the FDC system are used for calculating the “Thickness Prediction” indicator for each wafer.

The method of the present invention is first calibrated by processing a number of wafers, for example 100 wafers, and subjecting them to both virtual and in-line metrology.

The in-line metrology will generally provide a Gaussian distribution of actual thicknesses. From there, a 0-100% scale of prediction confidence will be used to “judge” each calculated virtual thickness (predicted thickness) during mass production of the fab. This indicator is named in the present description Model Reliability Quality Value (MRQV). From there, process engineer can decide if, for example, a MRQV confidence level under 80% requires the wafer to be sent to in-line metrology step. The MRQV value is calculated by the system through a loop Thickness Prediction/Metrology data correlation analysis and corresponding algorithm is continuously tuned accordingly.

More particularly, to execute the method of this invention, a correlation between plasma parameters and the resulting deposited thickness is established. In this regard, the flow chart of FIG. 2 shows that a Design Of Experiment (DOE)/Failure Mode & Effect Analysis (FMEA) for the specific tool type (in the present the HDP-CVD deposition equipment) is should be performed before the study. The list of parameters which impact deposited thickness value and/or uniformity is identified there, based on the analysis such as the one made above regarding high density plasma deposition behavior.

During each wafer deposition, the relevant parameter values are taken from the Fault Detection and Classification (FDC) data as explained above.

A so-called “Correlation Engine” calculates for each wafer a thickness prediction (value) and a confidence level MRQV (in percent). The Correlation Engine uses Mathematical algorithms based on the above plasma behavior know-how and on any required simulations.

Still referring to FIG. 2, a Pre-Treatment (an algorithm for data elaboration) is defined in the Equation Editor as other calculation/prediction equations that are used as the core of the “Correlation Engine”. Such Equation Editor is a standard part of the commercially available Maestria software product from the applicant.

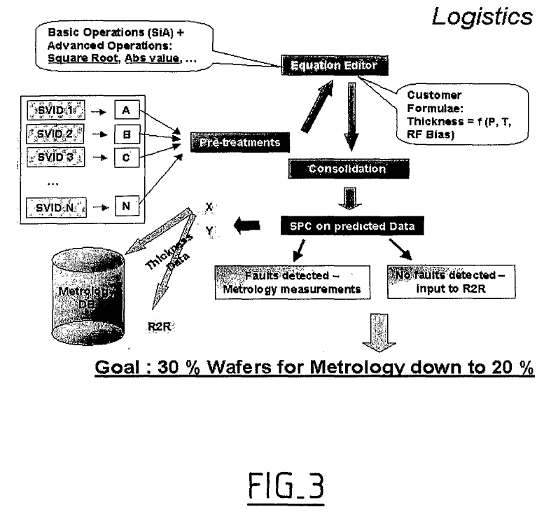

FIG. 3. Shows the general architecture into which the method of the present invention is integrated. The parameters are designated by standard indicators SVID 1, SVID 2, etc. (SVID for Status Variable IDentifier). Temporal data (e.g., temperature value reported every second through whole process duration) is filtered according to step, processing window and then reduced to a single point (a vector in the case of multiple variables) by applying a pre-treatment (e.g., mean, standard deviation, maximum, etc. algorithm). The pre-treated data (indicators) is further used in the formulae created in the Equation Editor for calculating the predicted deposited thickness together with the confidence value MRQV.

The predicted thickness and confidence value are sent to Statistical Process Control tools of the system, which decides whether the wafer is predicted to be faulty and should be sent to in-line metrology, or is predicted to be without defect and can continue without metrology to the next step of the fab process.

A possibility offered by the present invention is that the virtual metrology such as the virtual thickness prediction can be transmitted to the Manufacturing Execution System (MES) and “Feed Forward” to the following manufacturing step which—in the case of CVD deposition—most often is a Chemical-Mechanical Polishing (CMP) step.

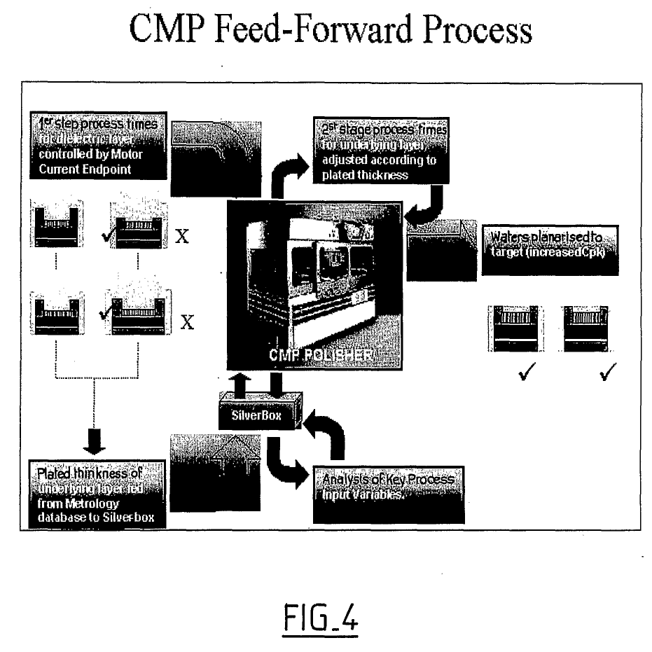

This predicted thickness value is used at that step as illustrated in FIG. 4 for estimating a possible over-polish time to improve post-polishing uniformity and to increase the so-called Process Capability Cpk.

It should be noted here that during a conventional CMP process, two phases are clearly separated—polishing and over-polishing. Polishing is stopped when End Point Detection (EPD) is achieved and its duration is strongly dependent on the underlying pattern density.

Once EPD is triggered, an over-polish (usually fixed time based) completes the polishing process. Conventionally, the over-polish time is calculated based on metrology measurements for the deposited thickness (typically in-line metrology data on dummy=non-production wafers) and on the polishing rate (estimated from the main polishing step as ended by EPD).

When a “Virtual Metrology” according to the method of the present invention is used instead, each single wafer at the output of the HDP-CVD equipment has a predicted thickness value, and this value allows to improve the accuracy of over-polish time calculation and thus to increase the polishing process capability Cpk as such.

It is thus understood that the present invention in such case provides a two-fold gain, i.e.:
a reduction of real metrology sampling, thus increasing process throughput and shortening the cycle time;
by the generation of virtual metrology output for each single wafer treated by the process, an increase of the efficiency (typically the Cpk value) of the combined deposition and polishing steps.

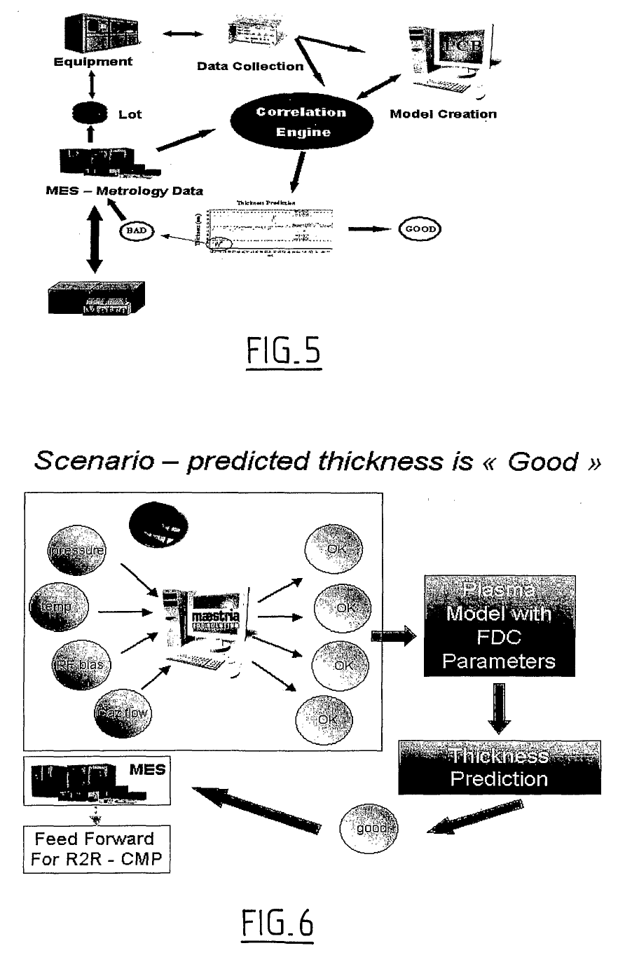

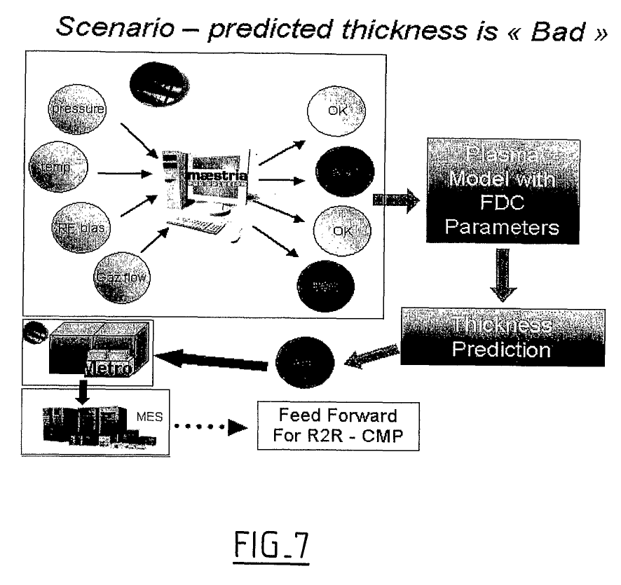

Preferably, all thickness data (predicted or measured) are retrofit into MES system for traceability (see FIG. 5). Thus, 100% Metrology coverage is ensured for deposition process. Further Yield Analysis can be performed by using FDC, In-line metrology and “Virtual Metrology” data correlation with Electrical Measurements at the end of the process.

### EXAMPLE

The above-described method has been applied to the real processing of Fluorine-doped Silicate Glass (FSG) deposition in HDP-CVD as the part of Pre-Metal layer deposition sequence. 81 wafers have been inspected by FDC and thickness prediction was performed and then matched with in-line metrology for 13 of them. The target thickness for the resulting FSG layer was 450 nm. Thickness prediction for each of the 13 wafers confronted to their in-line metrology in order to calibrate prediction algorithm.

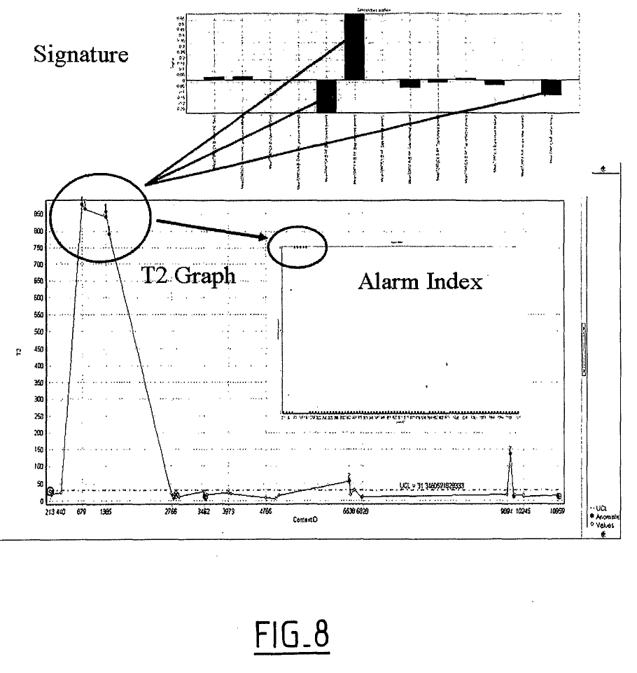

FIG. 8 represents the results of FDC analysis on the plasma-influent parameter values for each wafer by applying Hotelling T2 statistics with detection of “above the statistical limit” T2 values. It is reminded here that Hotelling T2 is a statistical measure of the multivariate distance for each observation from the center of the data set.

A “Black” Alarm Index (i.e., important anomalies with a multivariate deviation of more than 6 sigmas from process “normality”) was considered as representative of out-of-control for thickness predictions.

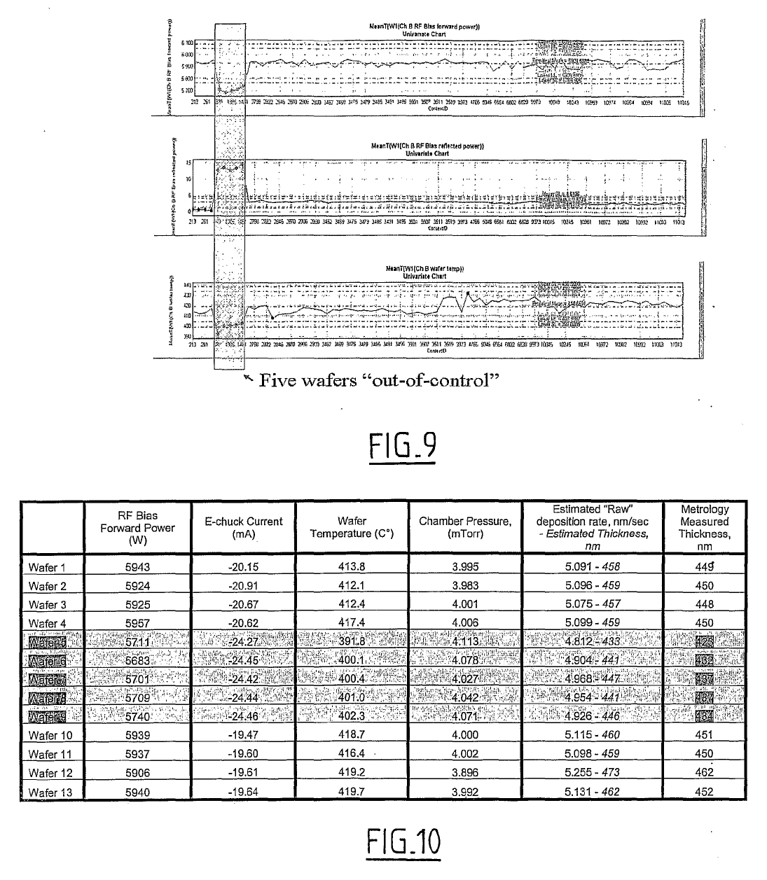

FIG. 8 Shows that five out-of-control wafers have been classified as Group 1 (signature shows three most impacted variables). In the present example, these most influent variables were considered as being “RF Bias Forward Power”, “RF Bias Reflected Power” and “Wafer Temperature”, and corresponding Univariate (SPC) graphs are represented in FIG. 9. Lower RF forward and higher reflected power result to the wafer lower temperature (due to the lower heat transfer). In this case “Plasma Density” and “Plasma Ion Mobility” are lower than during normal processing condition, thus resulting into the lesser film thickness with higher non-uniformity. This was confirmed by the in-line metrology measurements.

It is understood that estimations are not fully accurate due to the inherent inaccuracies and approximations in constructing a model from direct and indirect plasma parameters involved. This is the reason why the resulting thickness value has to be “scaled” with a corrective coefficient (cf. supra) based on the in-line metrology measurements data. This coefficient is to be used for all further predictions and is preferably to be adjusted (tuned) on a regular basis with help of in-line metrology check.

Of course, the present invention is not limited to the above description, but many variants can be derived by the one skilled in the art. In particular, the above description can be applied to different types of CVD (e.g., PECVD, SACVD and LPCVD) as well as to PVD (Physical Wafer Deposition=Sputtering) processes. Minor changes (such as calibration and different set of SVID) might be necessary to tune predictions. More generally, each process step where a modeling based on the output of a process control system can provide a quality value of the process result can benefit from the present invention, and tools as Maestria will help the one skilled in the art to construct the appropriate mathematical models.

1. A method for improving efficiency of a product manufacturing process such as a semiconductor fab process, wherein a given step of the process has a quality result which can be predicted for each product or group of products, comprising:
providing a correlation model of the performance of a given step as a function of available process parameters;
for each product or group of products at the output of said manufacturing step, computing a predicted quality result based on said correlation model as a function of the actual values of the parameters during the manufacturing step, and
only if the predicted quality result is lower than a predetermined threshold, selecting the product or group of products for in-line measurement.

2. A method according to claim 1, wherein the provided correlation model is a function of a complete set of available parameters, while the predicted quality result is a function of the incomplete set of actual values of the parameters during the manufacturing step.

3. A method according to claim 1, wherein said given step has no in-line measurements associated, and the said selecting step is only based on quality result of the prediction, and also on the predicted value for this product.

4. A method according to claim 1, wherein said predicted quality result includes a value and a degree of confidence of said value.

5. A method according to claim 4, further including a correlation model calibration step that is at least based on real quality result measurement for a limited of product samples.

6. A method according to any one of claims 1 to 5, wherein said process step is a plasma deposition step.

7. A method according to claim 6, wherein the said model calibration is at least based on final Electric Test or Yield results at the end of a processing sequence.

8. A method according to claim 1, wherein said manufacturing process further comprises a subsequent, adjustable step, the method further comprising providing the quality result to a control system for adjusting said subsequent step.

9. A method according to claims 6 and 8 taken in combination, wherein said subsequent step is a chemical mechanical polishing (CMP) step.

10. A method according to claim 9, wherein the adjustment of said CMP comprises adjustment of the duration of an over-polish phase of said subsequent step.

11. A method according to claims 6 and 8 taken in combination, wherein said subsequent step is an etching step.

12. A method for improving the efficiency of a product manufacturing process such as a semiconductor fab process, wherein a given step of the process has a quality result which can be actually measured on each product or group of products, and wherein the process comprises a subsequent, adjustable step, the method comprising:
providing a correlation model of the behavior of said given step as a function of available parameters;
for each product or group of products at the output of said manufacturing step, computing a predicted quality result based on said correlation model as a function of the actual values of the parameters during the manufacturing step, and
providing the quality result to a control system for adjusting said subsequent step.

13. A method according to claim 12, wherein said given step is a plasma deposition step and said subsequent step is a chemical mechanical polishing step.
